(19) United States
(12) Patent Application Publication
(10) Pub. No.: US 2002/0126716 A1
(43) Pub. Date: Sep. 12, 2002

(54) Dynamic laser output power optimization

(75) Inventor: Daniel A. Vreeland, Redondo Beach, CA (US)

Correspondence Address: LOWE HAUPTMAN GILMAN & BERNER, LLP, 1700 Diagonal Road, Suite310, Alexandria, VA, 22314, US

(73) Assignee: EXCELLON AUTOMATION CO.

(21) Appl. No.: 09/799,631

(22) Filed: Mar. 7, 2001

(51) Int. Cl. H01S 3/13

(52) U.S. Cl. 372/31

(57) ABSTRACT

The control of output power of a laser beam generated by a laser system is accomplished on a tool by tool basis, using a position setting of an optical attenuator in conjunction with a repetition rate parameter of the laser beam. Two tables of data points representative of output power of the laser beam as a function of laser frequency and attenuation are generated. A scale factor is determined based on one of the tables, and is used to scale data stored in the other. The scaled data is then used to determine settings necessary to obtain the required output power of the laser beam. The tables are configured to have increased granularity around maximum usage region of the laser frequency and attenuation working range. As a result, the process can be done with high accuracy and within a reasonable time.

### FIELD OF THE INVENTION

The present invention relates generally to a computer implemented method and apparatus for calibrating output power of laser systems, and more particularly, to a method and apparatus for dynamically optimizing output power of a laser system utilizing a system repetition rate adjustable feature alone or in conjunction with attenuation settings of the laser system.

### BACKGROUND OF THE INVENTION

Laser beam cutting/drilling applications are being widely used since work pieces can be cut or drilled to a complex contour at a high speed. In order to achieve high cutting/drilling accuracy, it is necessary to know the laser output power, i.e. energy per laser pulse, most suitable for the type of material to be treated. It is also important to know the total laser energy absorbed in the material to obtain proper exposure. In this connection, the repetition rate of the laser beam becomes a significant parameter. The repetition rate of a laser beam is the number of laser pulses in a unit time. An alternative term is “laser frequency”. At the same output power, i.e., same energy per pulse, and during the same amount of time, laser beams of different repetition rates will transfer to the work piece different accumulated doses, i.e., a different total amount of laser energy. The settings of output power and laser frequency together with other types of settings are incorporated for each type of material, such as polyamide or copper, in a recipe.

Recipe development has become an important type of laser application, especially in manufacturing printed circuit boards (PCB). In this type of application, a certain number of holes are drilled in a test work piece at various output power and laser frequency settings. The work piece is then cross sectioned, examined for quality feedback, and the test recipes are reiterated. Thus, there is a need for a method of adjusting output power of laser systems which allows the output power to be quickly and accurately switched back and forth among various available settings. To control the output power of laser systems, several approaches are known in the art.

One method of changing the pulse energy output from a laser is to lower or raise the voltage of the primary excitation device for the laser. However, it has been found that an excessive change in voltage excitation may cause instability of the laser discharge, and premature electrode wear.

Another approach is to use attenuators to limit output power of the system without disturbing the operation of the laser excitation device. However, attenuators are subject to many restrictions and disadvantages. For example, attenuators may experience optical damage due to direct exposure to the laser beam. The physical size of the attenuator should be limited. Alternatively, the attenuator should not optically degrade or distort the laser beam profile. Moreover, the attenuator is usually a mechanical device which, for example, rotates from one position to another position to provide the necessary attenuation effect. It often takes a long time to set the attenuator to a new position, and to stabilize the system output after such a process. Another drawback of the attenuator is mechanical backlash.

Thus, none of the above approaches can be adequately used in laser applications which require dynamic optimization of output power. A solution, however, can be provided in those laser systems which are equipped with a capability allowing the laser frequency to be adjusted on the fly, such as AVIA-type UV (ultraviolet) lasers made commercially available by Coherent Inc. By specifying laser frequency, the output power can be controlled more precisely, with better resolution as opposed to the optical attenuator. The other advantage is that adjusting output power through laser frequency is much quicker, almost instantaneous, and faster than adjusting the attenuator, especially in back and forth operations. The laser frequency is adjusted via command signals directly sent to the laser, and thus, no mechanical backlash is experienced.

Despite the above, there has been no effort to take advantage of the laser frequency adjustability feature, especially in optimizing the output power of the laser system. Moreover, there has been no effort to use both the laser frequency and attenuation settings in an output power optimizing process. In such a combined method, adjusting the laser frequency of the laser beam in small increments will provide fine control, while changing the attenuator position will provide coarse control over the output power of the system.

### SUMMARY OF THE INVENTION

It is an object of the present invention to provide a method of dynamically optimizing output power of a laser beam, which is especially suitable for laser systems equipped with the laser frequency adjustability feature, by taking advantage of such a feature.

It is a further object of the present invention to provide a computer implemented method and apparatus for use in a laser system equipped with an attenuator, which takes into account both laser frequency and attenuator settings to dynamically optimize the output power of a laser beam generated by the system.

It is another object of the invention to provide a computer implemented method and apparatus, especially suited for PCB recipe development applications, which allows for precise control of the laser output power and the laser frequency on a tool-by-tool basis, by utilizing an existing optical attenuator in conjunction with a repetition rate/laser frequency parameter.

These and other objects of the present invention are achieved by a method of dynamically optimizing output power of a laser beam generated by a laser system. The method comprises the steps of (i) providing the laser beam; and (ii) adjusting laser frequency of the laser beam to fine-tune the output power of the laser beam to a predetermined output power value with predetermined accuracy within a predetermined time period.

In accordance with an aspect of the invention, the method further comprises the step of controlling an opening of an attenuator provided in the laser system to coarse-tune the output power of the laser beam to the predetermined output power value. In accordance with another aspect of the invention, the laser frequency of the laser beam is adjusted only within a predetermined laser frequency range associated with the predetermined output power value.

The foregoing objects of the present invention are also achieved by a computer implemented method of dynamically optimizing output power of a laser beam generated by a laser system equipped with an attenuator. In accordance with the method, a first data set is created to be representative of laser output power which is measured at various laser frequency values throughout a laser frequency working range of the laser system, and at a specific position of the attenuator. A second data set is also created to be representative of laser output power which is measured at various positions throughout an attenuation working range of the attenuator, and at a specific laser frequency value. After that, the laser frequency of the laser beam and the position of the attenuator are adjusted, based on the first and second data sets, to tune the output power of the laser beam to a predetermined output power value.

In accordance with an aspect of the invention, after the two data sets have been created, for a selected laser frequency value and based on the first data set, a selected laser output power value associated with the selected laser frequency value is determined. Then, a power scale factor is determined based on the selected laser output power value and a maximum laser output power value of the first data set. Next, the laser output power values of the second data set are scaled according to the power scale factor. Finally, based on the scaled laser output power values of the second data set, a selected position of the attenuator is determined corresponding to the predetermined output power value.

In accordance with another aspect of the invention, the output power of the laser beam is reassessed, based on the selected position of the attenuator and the scaled laser output power values of the second data set.

The foregoing objects of the present invention are also achieved by a computer architecture for dynamically optimizing output power of a laser beam generated by a laser system equipped with an attenuator. The computer architecture comprises means for creating a first data set representative of laser output power measured at various laser frequency values throughout a laser frequency working range of the laser system, and at a specific position of the attenuator. The computer architecture also comprises means for creating a second data set representative of laser output power measured at various positions throughout an attenuation working range of the attenuator, and at a specific laser frequency value. Means for adjusting is provided to adjust the laser frequency of the laser beam and the position of the attenuator, based on the first and second data sets, to tune the output power of the laser beam to a predetermined output power value.

The foregoing objects of the present invention are also achieved by a computer system for dynamically optimizing output power of a laser beam generated by a laser system equipped with an attenuator. The computer system comprises a processor and a memory coupled to the processor. The memory has stored therein sequences of instructions, which, when executed by the processor, cause the processor to create a first data set representative of laser output power measured at various laser frequency values throughout a laser frequency working range of the laser system, and at a specific position of the attenuator. Next, the processor is caused to create a second data set representative of laser output power measured at various positions throughout an attenuation working range of the attenuator, and at a specific laser frequency value. Finally, the processor is caused to adjust the laser frequency of the laser beam and the position of the attenuator, based on the first and second data sets, to tune the output power of the laser beam to a predetermined output power value.

The foregoing objects of the present invention are also achieved by an article, for use in dynamically optimizing output power of a laser beam generated by a laser system equipped with an attenuator. The article comprises at least one sequence of machine readable instructions in machine readable form. The execution of the instructions by one or more processors causes the one or more processors to create a first data set representative of laser output power measured at various laser frequency values throughout a laser frequency working range of the laser system, and at a specific position of the attenuator. Next, the one or more processors is/are caused to create a second data set representative of laser output power measured at various positions throughout an attenuation working range of the attenuator, and at a specific laser frequency value. Finally, the one or more processors is/are caused to adjust the laser frequency of the laser beam and the position of the attenuator, based on the first and second data sets, to tune the output power of the laser beam to a predetermined output power value.

### BRIEF DESCRIPTION OF THE DRAWINGS

The present invention is illustrated by way of example, and not by limitation, in the figures of the accompanying drawings, wherein elements having the same reference numeral designations represent like elements throughout, and wherein:

FIG. 1 is a high-level block diagram of an exemplary computer system with which the present invention can be implemented;

FIG. 2 is a block diagram showing main components of a laser system which are controlled by an application program implementing the invention and residing in a computer system such as the one shown in FIG. 1;

FIG. 3 is a flow chart illustrating the processes performed in accordance with an implementation of the invention; and

FIGS. 4A and 4B are graphs illustrating data manipulation in accordance with the implementation shown in FIG. 3.

### BEST MODE FOR CARRYING OUT THE INVENTION

A method of and apparatus for optimizing output power of a laser beam generated by a laser system according to the present invention are described. In the following detailed description, for purposes of explanation, numerous specific details are set forth in order to provide a thorough understanding of the present invention. It will be apparent, however, that the present invention may be practiced without these specific details. In other instances, well-known structures and devices are shown in block diagram form in order to simplify the drawing.

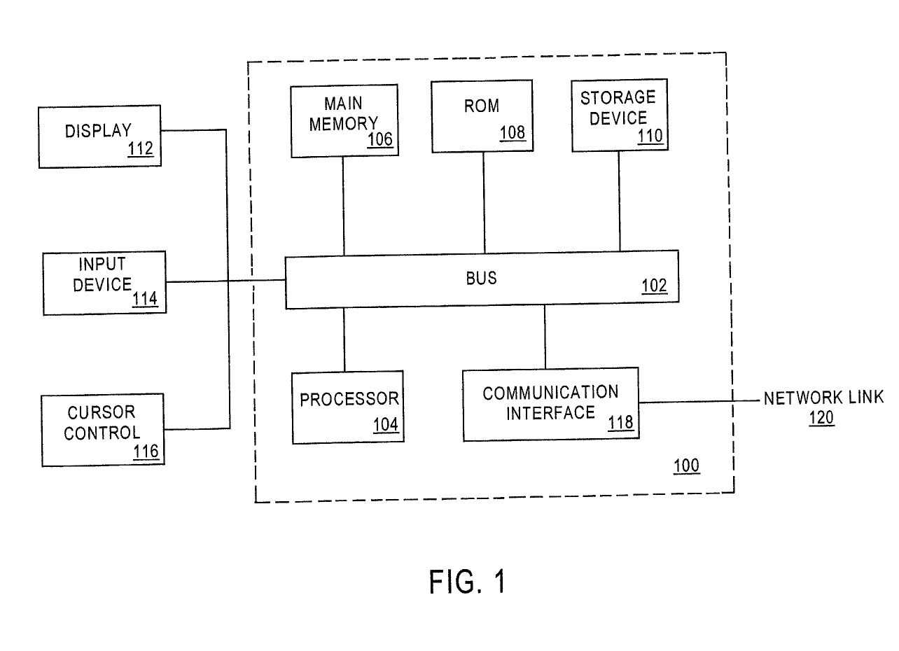

FIG. 1 is a high-level block diagram illustrating an exemplary computer system 100 with which the present invention can be implemented. The present invention is usable with currently available personal computers, mini-mainframes and the like.

The computer system 100 includes a bus 102 or other communication mechanism for communicating information, and a processor 104 coupled with the bus 102 for processing information. The computer system 100 also includes a main memory 106, such as a random access memory (RAM) or other dynamic storage device, coupled to the bus 102 for storing information and instructions to be executed by the processor 104. The main memory 106 may also be used for storing temporary variables or other intermediate information during execution of instructions to be executed by the processor 104. The computer system 100 further includes a read only memory (ROM) 108 or other static storage device coupled to the bus 102 for storing static information and instructions for the processor 104. A storage device 110, such as a magnetic disk or optical disk, is provided and coupled to the bus 102 for storing information and instructions.

The computer system 100 may be coupled via the bus 102 to a display 112, such as a cathode ray tube (CRT) or a flat panel display, for displaying information to a computer user. An input device 114, including alphanumeric and other keys, is coupled to the bus 102 for communicating information and command selections to the processor 104. Another type of user input device is a cursor control 116, such as a mouse, a trackball, or cursor direction keys for communicating direction information and command selections to the processor 104 and for controlling cursor movement on the display 112. This input device typically has two degrees of freedom along two axes, a first axis (e.g., x) and a second axis (e.g., y) allowing the device to specify positions in a plane.

According to one embodiment of the invention, a variety of information and services are provided by the computer system 100 in response to the processor 104 executing sequences of instructions contained in the main memory 106. Such instructions may be read into the main memory 106 from another computer-readable medium, such as a storage device 110. However, the computer-readable medium is not limited to devices such as the storage device 110. For example, the computer-readable medium may include a floppy disk, a flexible disk, hard disk, magnetic tape, or any other magnetic medium, a CD-ROM, DVD-ROM, or any other optical medium, punch cards, paper tape, or any other physical medium with patterns of holes, a RAM, a PROM, an EPROM, a FLASH-EPROM, or any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below.

In alternative embodiments, hard-wired circuitry may be used in place of or in combination with computer software instructions to implement the invention. Thus, embodiments of the invention are not limited to any specific combination of hardware circuitry and software.

The computer system 100 also includes a communication interface 118 coupled to the bus 102. The communication interface 108 provides a two-way data communication as is known. For example, the communication interface 118 may be an integrated services digital network (ISDN) card, a digital subscriber line (DSL) card, a cable modem, or a telephone modem to provide a data communication connection to a corresponding type of communication line. As another example, the communication interface 118 may be a local area network (LAN) card to provide a data communication connection to a compatible LAN. Wireless links may also be implemented. In any such implementation, the communication interface 118 sends and receives, through a data communication connection 120, electrical, electromagnetic or optical signals which carry digital data streams representing various types of information.

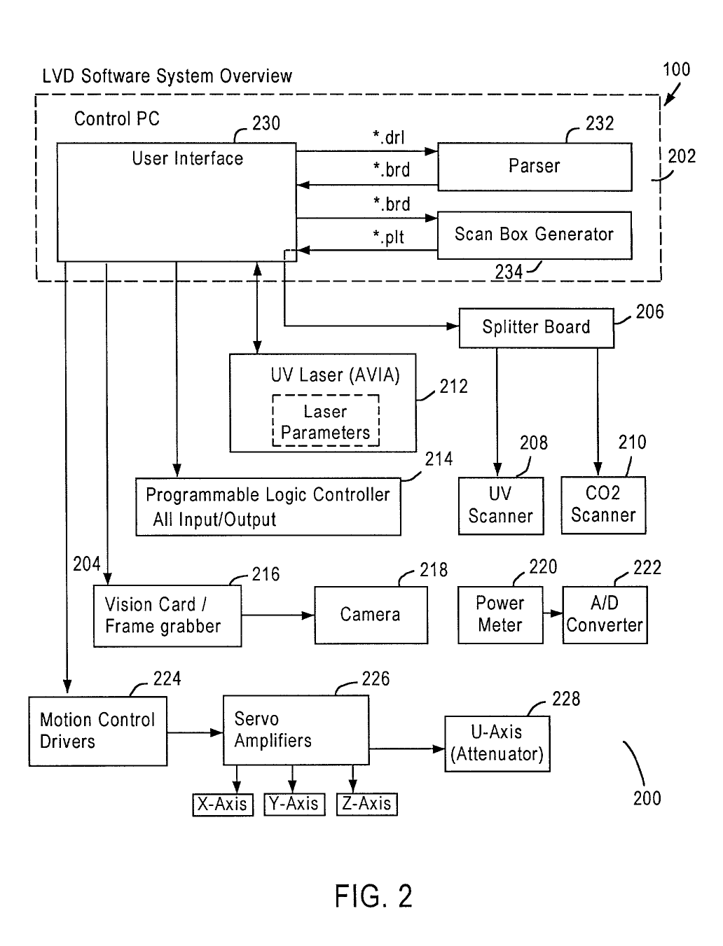

An optimizing program 202 of the invention, which runs in the hardware platform of the computer system 100 to control a laser system 200, will be now described with reference to FIG. 2.

The optimizing program 202 includes a user interface 230, a parser 232, and a scan box generator 234. Generally, the user interface 230 provides a user with necessary control over the execution of the optimizing program 202. For example, the user interface 230 allows the user to vary numerous parameters of the laser system 200, such as output power, laser pulse repetition rate, laser frequency increment, etc. The scan box generator 234 issues commands to a splitter board 206 to selectively fire laser beams from appropriate scanners, which in this particular example are a UV scanner 208 and a CO₂ scanner 210. The user interface 230, parser 232 and scan box generator 234 communicate with each other by generating and accessing numerous files of proprietary formats, as shown in FIG. 2.

More particularly, the parser 232 is a stand-alone software program which receives drill information and converts it into, e.g., two files that the drilling machine then uses internally: the “*.brd” (board) and “*.bin” (binary) files. The board file contains drill job information (setup definition, tool/skiving parameters, alignment information, etc.) and the binary file contains the actual x,y position data (the “hole” information).

The scan box generator 234 is another stand-alone software program. The scan box generator 234 accesses the “aligned” copy of the internal drill job data previously created by the parser 232, and then creates a series of data objects which are used by the scanners during the actual drilling sequence. Each laser has a set of “scan box” data objects that define a table position and appropriate scanner information, used by the system, in order to properly drill or “mark” a specific area on the work piece.

In a preferred embodiment of the invention the code of the optimizing program 202, or LVD (Laser Via Driller) software, is written in Visual Basic 6 with several standalone executable modules compiled from Borland Delphi code for maximum speed of execution. The LVD software uses a central foundation module (not shown) as a hub around which all other modules operate. All processes within the software register themselves with the foundation module as they start and end, so the foundation module can prevent incompatible processes from clashing. The foundation module also handles User Abort commands stopping all processes from running. It is a central controller that keeps track of the current system status. It is the only form that is always active, and it is used to hold the RS232 communication controls, and error detection timer loops. Apparently, any other programming language and logical architecture can be used instead, without departing from the scope and spirit of the invention.

The optimizing program 202 has control of the numerous components of the laser system 200, such as a vision system 204, the scanners 208 and 210, stage movement or motion control 224, lasers 212 and a programmable logic controller (PLC) 212. The vision system 204 comprises a video processing board (vision card/frame grabber) 216 which also acts as a display device. A CCD (Charge Coupled Device) camera 218 and zoom lens (not shown) with coaxial variable illumination feed an image of the board surface to the video processing board 216. The main use of the vision system 204 is to pick up fiducials for board alignment. Respective drivers of the video processing board 216 are used to control frame capture and blob analysis. Illumination levels are controlled via an analogue output of the PLC 214. The zoom lens is controlled by digital PLC signals. The center of the CCD image in maximum zoom is taken as the datum about which all the other devices are positioned. The XY offsets of the two scanners 208 and 210, and a LDS (Linear Displacement Sensor) height sensor (not shown) are all measured with respect to the center of the vision field. The LDS height sensor is used for taking precise measurements in the Z-axis direction to focus the camera and lasers onto the surface of the work piece. The LDS height sensor then returns a linear voltage with respect to the height of an object placed beneath it.

A power meter 220 is provided to measure output power of the laser system 200 at a surface of the work piece. Alternatively and/or additionally, power meters or sensors can be installed at outputs of other components in the laser system 200, such as optics. The power meter 220 is a thermal detector which gives a linear voltage output as a function of the amount of incident laser radiation hitting the device's sensing surface. In a preferred embodiment of the invention the power meter 220 is positioned under the relevant scanner (208 or 210) and moved away from the focal plane. Then the laser is turned on to hit the detector. The voltage output is returned to the PLC 214 via an A/D (analog-digital) converter 222. The count from the A/D converter 222 is converted to watts using a calibration factor stored in the registry. The only way to fire the lasers is via the scanners 208 and 210 because all fire control signals of both lasers are controlled by the scanner hardware. The LVD software simply initiates a scan job which fires the lasers through the center of the scan lens for a predetermined time. Just before the scanner turns the beam off, the LVD software takes a series of readings from the PLC 214, takes average of the readings, and displays as a calibrated energy reading.

The UV laser 212 has a number of parameters that can be interrogated and controlled by the optimizing program 202. An example of a laser parameter that can be modified is the repetition rate of the laser output pulses. The motion control 224 controls a servo amplifier 226 (stages XYZ) and an attenuator 228 which, in this particular example, is an optical attenuator. However, the invention is not limited to the specific details set forth above. For example, any type of laser, not necessarily UV laser, which allows for a laser frequency (or repetition rate) adjustment will be adequate for the purpose of the invention. Likewise, the attenuator 228 can be of any type known in the art.

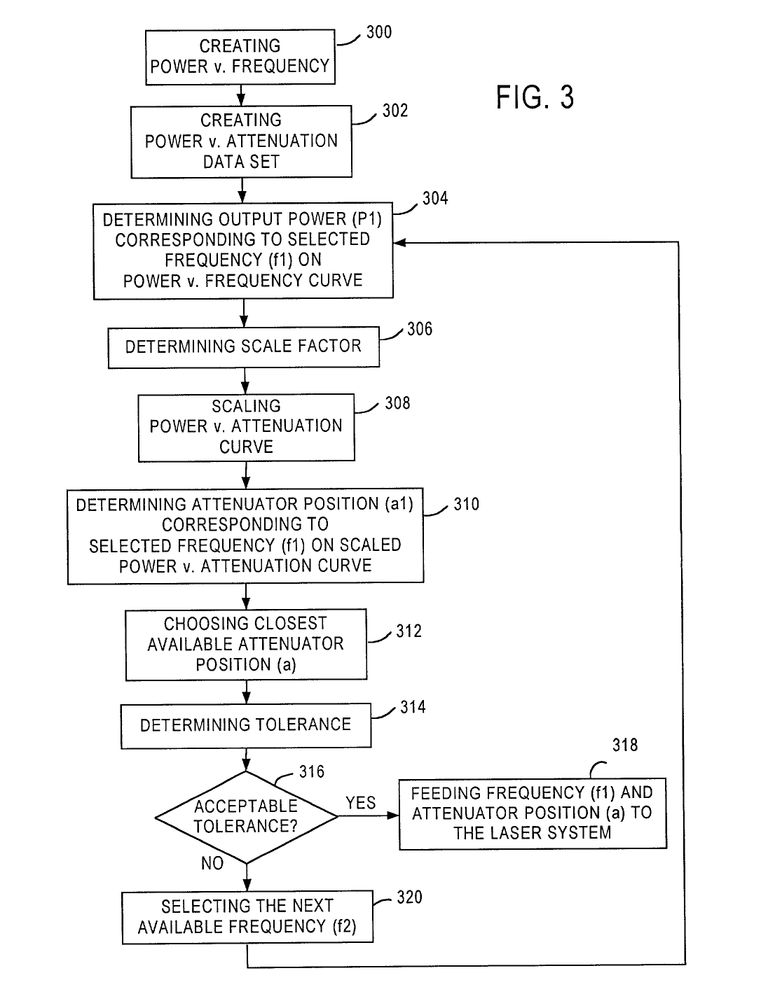

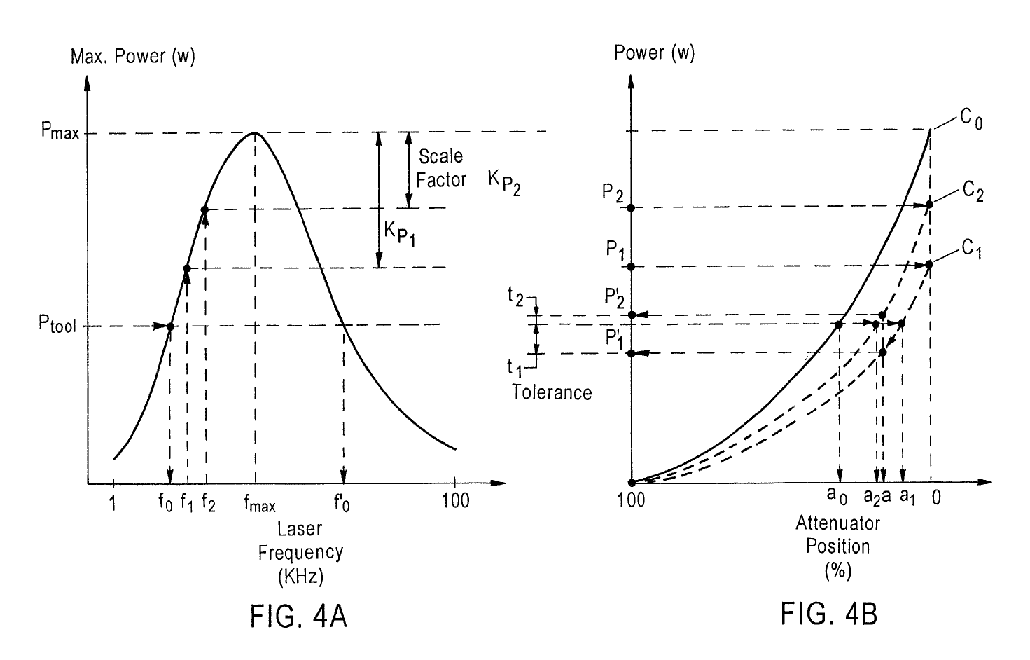

The method of dynamically optimizing output power of a laser beam generated by the laser system 200 will be now explained with reference to FIGS. 3 and 4A-4B.

First of all, a Power v. Frequency data set representative of laser output power as a function of laser frequency is created, at step 300. For this purpose, output power of the laser beam is measured, at a fixed position of the attenuator 228, for a series of various laser frequency values within the working range of the laser system. Typically, a laser system can produce laser beams with laser repetition rate of from 1 shot per second to 100,000 shots per second., i.e. with laser frequency of from 1 Hz to 100 kHz. Current laser systems find practical application in the frequency range of from 1 kHz to 100 kHz which is also used in an embodiment of the invention.

Based on the measured Power v. Frequency data set, a Power v. Frequency characteristic can be constructed. Typically, the Power v. Frequency characteristic will have a high output power peak Pₘₐₓ corresponding to a laser frequency value fₘₐₓ in the middle of the frequency working range, and much lower output power values at the boundaries of the frequency working range, as shown by solid line in FIG. 4A. The values Pₘₐₓ and fₘₐₓ vary from laser system to laser system. In the above mentioned embodiment of the invention, Pₘₐₓ is about 2.5W while fₘₐₓ is found in a range from 20 to 27 kHz.

Similarly, a Power v. Attenuation data set representative of laser output power as a function of attenuation is also created, at step 302. For this purpose, output power of the laser beam is measured, at a fixed laser frequency value, for a series of various positions within the working range of the attenuator 228. Typically, the attenuator 228 can be adjusted to different working positions from 100% attenuation (fully closed) to 0% attenuation (fully open).

Based on the measured Power v. Attenuation data set, a Power v. Attenuation characteristic can be constructed. Typically, the Power v. Attenuation characteristic will have an exponential form with the lowest (zero) output power value at 100% attenuation, and the highest output power value at 0% attenuation, as shown by solid line (curve c₀) in FIG. 4B.

In a preferred embodiment of the invention, the Power v. Frequency data points are measured when the attenuator 228 is left fully open (0% attenuation). The Pₘₐₓ value will be the maximum power that the laser system 200 can output. The fₘₐₓ value is determined from the Power v. Frequency characteristic, and then the Power v. Attenuation data points are measured at the fixed fₘₐₓ value. In this preferred embodiment, the highest output power value at 0% attenuation shown in curve c₀ will be the maximum power that the laser system 200 can output, Pₘₐₓ.

In operation of the laser system 200, it may not be necessary to use the maximum power Pₘₐₓ all the time. A drilling or cutting job may require a tool which specifies an output power value other than the maximum power, e.g. Pₜₒₒₗ as shown in FIG. 4A. A tool is basically a set of parameters which describe the laser settings for a particular job. There is a number of parameters that vary, for example in a drill job, from hole to hole. The tool setting may specify the diameter of the actual hole, or a particular physical position on the PCB substrate. A small difference in tool settings may result in different diameter, different shape or different characteristic optimal drilling speed or ability to cut a certain amount of material per unit time. Output power and repetition rate are very important parameters in a tool setting.

In the simplest situations, the required Pₜₒₒₗ value can be obtained when attenuator 228 is lest fully open (0% attenuation) and the laser beam is outputted with laser frequency f₀ or f₀′, as shown in FIG. 4A. Alternatively, the required Pₜₒₒₗ value can be obtained when the laser frequency of the laser beam is set at fₘₐₓ and the attenuator 228 is set at position a₀, as shown in FIG. 4B. Thus, more than one setting are available and any of the above settings can be fed by the optimizing program 202 to the laser system 200 to achieve the desired Pₜₒₒₗ at an output thereof.

However, output power is not the only parameter that needs to be considered when developing an LVD tool recipe for a particular application and material composition. These tool settings, typically refined experimentally from baseline values, strive to optimize cutting speed while maintaining the best hole quality or feature appearance. One of the parameters of interest in developing tool recipes for different materials is the adjustable Laser Repetition Rate that determines the output pulse frequency of the laser beam. This adjustment provides needed control over the average power and the peak energy per pulse in order to drill, route or cut a wide range of materials with a variety of physical properties.

For instance, for typical microvia drilling applications, the baseline Repetition Rate variable is typically set to the 20-27 KHz range thus providing the maximum average laser power and thereby minimizing the total job execution time. If it is desired to use the laser beam to do a “clean-up” operation on a dielectric layer without damaging nearby metalization layers, the appropriate tool frequency range might be in the 50-70 KHz range for common printed circuit board materials. At the other end of the frequency spectrum, if the material had “ceramic” like properties, it would be most likely to use a 57 KHz setting in order to achieve the highest possible peak energy per pulse from the laser beam.

Thus, if the laser system 200 is required to generate a laser beam of the output power Pₜₒₒₗ and at a laser frequency within a specific range Fₜₒₒₗ (not shown) for a specific application, and the laser frequency value f₀, f₀′, and fₘₐₓ do not fall within the specific range Fₜₒₒₗ, it will be necessary to set the laser frequency within the specific range Fₜₒₒₗ and find a corresponding position of the attenuator 228 to satisfy the output power Pₜₒₒₗ requirement.

For this purpose, a laser frequency value f₁ is selected inside the range Fₜₒₒₗ, and, at step 304, an output power value P₁ corresponding to the selected laser frequency value f₁ is determined from the Power v. Frequency curve, as shown in FIG. 4A. A scale factor kₚ₁ is calculated by dividing the determined output power value P₁ by the maximum power Pₘₐₓ, and the scale factor kₚ₁ is used to scale the Power v. Attenuation curve accordingly, at steps 306 and 308. Thus, a scaled Power v. Attenuation data set is created and presented as curve c₁ in FIG. 4. This scaled data set represents output power values at various positions of the attenuator 228 when the laser frequency is set at f₁, instead of fₘₐₓ in the case original curve co. An attenuator position a₁ corresponding to the required output power value Pₜₒₒₗ is found, at step 310, on the scaled Power v. Attenuation curve, as shown in FIG. 4B. If a setting of f₁ and a₁ is fed to the laser system 200, it will generate a laser beam of output power Pₜₒₒₗ and yet ensuring that the laser frequency of the laser beam will fall within the required range Fₜₒₒₗ.

It has already been mentioned in the foregoing discussion that the laser frequency can be adjusted with very fine increments, while the attenuator 228 provides only some coarse control due to mechanical backlash of the driving mechanism. It may turn out that the mathematically calculated attenuator position a₁ is not available in the actual attenuator 228. In this situation, an actual attenuator position a, which is usually closest to the calculated a₁, is chosen instead, at step 312. If a new real-life setting of f₁ and a is fed to the laser system 200, it will generate a laser beam at the required laser frequency f₁, but with a different output power P₁′, as shown in FIG. 4B.

The new setting of f₁ and a will still be acceptable if the required Pₜₒₒₗ and the actual output power P₁′ are close enough, that is the tolerance t₁, shown in FIG. 4B, between the two values is not higher than a predetermined threshold. This evaluation may be performed at steps 314. Alternatively, the new setting of f₁ and a may be immediately fed to the laser system 200, at step 318.

The whole optimizing process may be repeated for another frequency value f₂, chosen within another frequency range. The optimizing process for new frequency value f₂ is performed in a similar manner. An output power value P₂ corresponding to the laser frequency value f₂ is determined from the Power v. Frequency curve, as shown in FIG. 4A. A scale factor kₚ₂ is calculated by dividing the determined output power value P₂ by the maximum power Pₘₐₓ, to be used in scaling the Power v. Attenuation curve accordingly. A new scaled Power v. Attenuation data set is created and presented as curve c₂ in FIG. 4. This scaled data set represents output power values at various positions of the attenuator 228 when the laser frequency is set at f₂. An attenuator position a₂ corresponding to the required output power value Pₜₒₒₗ is found on the new scaled Power v. Attenuation curve, as shown in FIG. 4B. An actual attenuator position, e.g. a, which is closest to the calculated a₂, is chosen, and an actual output power value P₂′ corresponding to the actual attenuator position a is determined. Then, the new setting of f₂ and a will be fed to the laser system 200.

Though in the above described preferred embodiment, a scale factor, which is determined based on the Power v. Frequency characteristic, is used to scale the Power v. Attenuation curve, the reverse is true as well. That is, for a selected position of the attenuator 228, an output power value corresponding to the selected attenuator position is determined from the Power v. Attenuation curve. A scale factor is then calculated and used in scaling the Power v. Frequency curve accordingly. A new scaled Power v. Frequency data set is created to represent output power values at various laser frequency values when the attenuator 228 is set at the selected position. A laser frequency value corresponding to the required output power value Pₜₒₒₗ is found on the scaled Power v. Frequency curve, and the tolerance may then be calculated and evaluated.

Generally, a time period required for optimizing output power of a laser system should not be longer than 1-2 minutes. At the same time, the accuracy of 1-2% must be achieved. These are two conflicting requirements which must be appropriately balanced. In the preferred embodiment of the invention, the values P₁ and P₂, a₁ and a₂ etc. may not be previously stored in the two data sets, and are interpolated from the data points of the two data sets. Among many available interpolation techniques, the preferred embodiment of the invention uses linear interpolation technique. Clearly, more complicated interpolation techniques provide more accurate curve reconstruction but, at the same time, impose heavier processing loads on the computer system 100, and thus, requires more time to perform the optimizing process. Increasing the number of data points in each of the Power v. Attenuation and Power v. Frequency data sets can also lead to more precise interpolation results. However, the larger the data sets are, i.e. the more data points they contain, the longer time the optimizing program 202 requires to process the data sets.

A compromise is obtained by proving more data points in the region(s) of maximum usage, and less data points in other regions of the working range which are not likely to be used by laser applications. For example, the Power v. Frequency in accordance with an embodiment of the invention contains 24 data points measured at 1, 5, 5.5, 6, 6.5, 7, 7.5, 8, 8.5, 9, 9.5, 10, 12.5, 15, 17.5, 20, 25, 30, 40, 50, 60, 70, 85, 100 kHz. It will be noted that, the frequency in this series steps with a small increment of 0.5 kHz in the region from 5 to 10 kHz, while frequency increments in other regions, e.g. from 0 to 5 and from 10 to 100 kHz are much larger. In this manner, the accuracy in the region(s) of maximum usage, i.e. 5-10 kHz for this particular laser system, is increased while the total number of data point is kept at an appropriate level. It is also worthwhile noting that the region(s) of maximum usage is(are) usually found around the frequency value fₘₐₓ which corresponds to the maximum power Pₘₐₓ. Apparently, for another laser system which provides the maximum power at a frequency in the region between, e.g. 15 and 30 kHz, the density of data point will be increased in this 15-30 kHz region, instead of the 5-10 kHz region as shown above.

The advantages of the optimizing methods in accordance with the present invention are obvious given the above description and discussions. For example, methods of the invention allow precise optimization of output power at any and all tool settings, with easy and sufficiently fast switching from one tool to another. This greatly simplifies the recipe development process in which appropriate tool settings can be established for various types of materials and applications with reduced time and effort.

While there have been described and illustrated specific embodiments of the invention, it will be clear that variations in the details of the embodiments specifically illustrated and described may be made without departing from the true spirit and scope of the invention as defined in the appended claims.

What is claimed is:

1. A method of dynamically optimizing output power of a laser beam generated by a laser system, said method comprising the steps of
a) providing the laser beam; and
b) adjusting laser frequency of the laser beam to fine-tune the output power of the laser beam to a predetermined output power value with predetermined accuracy within a predetermined time period.

2. The method of claim 1, comprising further the step of controlling an opening of an attenuator provided in the laser system to coarse-tune the output power of the laser beam to the predetermined output power value.

3. The method of claim 1, wherein the predetermined accuracy is about 1-2%.

4. The method of claim 1, wherein the laser frequency of the laser beam is adjusted only within a predetermined laser frequency range associated with the predetermined output power value.

5. A computer implemented method of dynamically optimizing output power of a laser beam generated by a laser system equipped with an attenuator, said method comprising the steps of:
a) creating a first data set representative of laser output power measured at various laser frequency values throughout a laser frequency working range of the laser system, and at a specific position of the attenuator;
b) creating a second data set representative of laser output power measured at various positions throughout an attenuation working range of the attenuator, and at a specific laser frequency value; and
c) adjusting the laser frequency of the laser beam and the position of the attenuator, based on the first and second data sets, to tune the output power of the laser beam to a predetermined output power value.

6. The method of claim 5, wherein the laser frequency working range of the laser system comprises from 1 kHz to 100 kHz.

7. The method of claim 5, wherein the attenuation working range of the attenuator comprises from 0% to 100%.

8. The method of claim 5, wherein the specific position of the attenuator is a fully open position of the attenuator.

9. The method of claim 8, wherein the specific laser frequency value corresponds to a maximum laser output power value of the first data set.

10. The method of claim 5, wherein said step of adjusting includes the steps of:
(ci) for a selected laser frequency value and based on the first data set, determining a selected laser output power value associated with the selected laser frequency value;
(cii) determining a power scale factor based on the selected laser output power value and a maximum laser output power value of the first data set;
(ciii) scaling laser output power values of the second data set according to the power scale factor; and
(civ) based on the scaled laser output power values of the second data set, determining a selected position of the attenuator corresponding to the predetermined output power value.

11. The method of claim 10, wherein the selected laser frequency value is chosen within a predetermined laser frequency range associated with the predetermined output power value.

12. The method of claim 10, wherein steps ci) comprises interpolating the selected laser output power value from data points of the first data set.

13. The method of claim 14, wherein said interpolating comprises linear interpolating.

14. The method of claim 5, wherein a density of data points of the first data set is highest in the vicinity of a maximum laser output power value of the first data set.

15. The method of claim 5, wherein said step of adjusting includes the steps of:
(cv) for a selected position of the attenuator and based on the second data set, determining a selected laser output power value associated with the selected position of the attenuator;
(cvi) determining a power scale factor based on the selected laser output power value and a maximum laser output power value of the second data set;
(cvii) scaling laser output power values of the first data set according to the power scale factor; and
(cviii) based on the scaled laser output power values of the first data set, determining a selected laser frequency value corresponding to the predetermined output power value.

16. A computer architecture for dynamically optimizing output power of a laser beam generated by a laser system equipped with an attenuator, said computer architecture comprising:
b) means for creating a first data set representative of laser output power measured at various laser frequency values throughout a laser frequency working range of the laser system, and at a specific position of the attenuator;
c) means for creating a second data set representative of laser output power measured at various positions throughout an attenuation working range of the attenuator, and at a specific laser frequency value; and
e) means for adjusting the laser frequency of the laser beam and the position of the attenuator, based on the first and second data sets, to tune the output power of the laser beam to a predetermined output power value.

17. A computer system for dynamically optimizing output power of a laser beam generated by a laser system equipped with an attenuator, said computer system comprising:
a processor; and
a memory coupled to the processor, the memory having stored therein sequences of instructions, which, when executed by the processor, cause the processor to perform the steps of:
creating a first data set representative of laser output power measured at various laser frequency values throughout a laser frequency working range of the laser system, and at a specific position of the attenuator;
creating a second data set representative of laser output power measured at various positions throughout an attenuation working range of the attenuator, and at a specific laser frequency value; and
adjusting the laser frequency of the laser beam and the position of the attenuator, based on the first and second data sets, to tune the output power of the laser beam to a predetermined output power value.

18. An article, for use in dynamically optimizing output power of a laser beam generated by a laser system equipped with an attenuator, said article comprising at least one sequence of machine readable instructions in machine readable form, wherein execution of the instructions by one or more processors causes the one or more processors to perform the steps of:
creating a first data set representative of laser output power measured at various laser frequency values throughout a laser frequency working range of the laser system, and at a specific position of the attenuator;
creating a second data set representative of laser output power measured at various positions throughout an attenuation working range of the attenuator, and at a specific laser frequency value; and
adjusting the laser frequency of the laser beam and the position of the attenuator, based on the first and second data sets, to tune the output power of the laser beam to a predetermined output power value.
